(19) United States
(12) Patent Application Publication
(10) Pub. No.: US 2025/0367488 A1
(43) Pub. Date: Dec. 4, 2025

(54) AUTOMATICALLY DEPLOYING FLAME SUPPRESSION SYSTEM

(71) Applicant: Warren Watts Technology, LLC, Fort Worth, TX (US)

(72) Inventor: Brent Williams, Fort Worth, TX (US)

(73) Assignee: Warren Watts Technology, LLC, Fort Worth, TX (US)

(21) Appl. No.: 19/221,796

(22) Filed: May 29, 2025

Related U.S. Application Data
(60) Provisional application No. 63/653,554, filed on May 30, 2024.

(51) Int. Cl. A62C 35/10; A62C 3/00

(52) U.S. Cl. CPC A62C 35/10; A62C 3/006

(57) ABSTRACT

A fire suppression system that deploys automatically in response to an open flame. The system includes a fuse, a cover, a pivot arm rotatingly coupled to the cover, and a canister secured to the pivot arm. Helical walls extend downward from the pivot arm that rest on the ends of fingers that attach to the cover. The fuse, when intact, interferes with relative rotation of the pivot arm with the cover. The fuse becomes degraded when combustion is initiated from exposure to the open flame. Degrading the fuse allows the pivot arm to rotate and position the canister over the flame, which causes the canister to release a fire suppressing agent that extinguishes the flame. A spring biases the arm away from the cover, without the fuse, the arm rotates and moves downward due to interaction of the fingers with the helical walls.

### CROSS-REFERENCE TO RELATED APPLICATIONS

This application claims priority to and the benefit of co-pending U.S. Provisional Application Ser. No. 63/653,554, filed May 30, 2024, the full disclosure of which is incorporated by reference herein in its entirety and for all purposes.

### BACKGROUND OF THE INVENTION

### 1. Field of Invention

The present disclosure relates to a flame suppression system that deploys automatically.

### 2. Description of Prior Art

Stovetop fires can be inadvertently ignited when, e.g., a pan of grease is left unattended on a heating element of a stove. If not promptly extinguished, a stovetop fire can spread to surrounding structures and cause significant damage and injury. To mitigate the risk of stovetop fires, automatically activated fire extinguishing devices have been developed for mounting above a stovetop, e.g., within a range hood or under a microwave oven mounted over the stovetop. In the event of a stovetop fire, these devices typically release a fire suppressant material from a canister onto the stovetop, thereby extinguishing the fire.

Examples of automatically activated fire suppressing systems are described in commonly owned Williams et al., U.S. Pat. No. 9,339,672 (“Williams et al '672”) and Procious et al., U.S. Pat. No. 9,440,101 (“Procious et al '101”), which are incorporated herein by reference in their entireties and for all purposes. Known devices are subject to binding when deploying fire suppressing materials, occupy a large amount of space, and have unflexible mounting hardware. Therefore a need exists for flame suppression systems that reliably operate, are compact, and are adaptable to different mounting surfaces.

### SUMMARY OF THE INVENTION

Disclosed is an example of a fire suppression system that includes a cover having a planar portion and an elongated finger depending from the planar portion, a pivot arm having a base with a helically shaped wall projecting axially therefrom and having a terminal end in interfering contact with an end of the finger, so that when biased away from the cover the pivot arm rotates with respect to the cover from a stowed configuration to a deployed configuration, and a canister secured to the pivot arm containing a fire suppressant. The terminal end of the wall is optionally in sliding contact with a tip formed on an end of the finger. In an embodiment, the wall is a first wall and the system further includes a second helically shaped wall that projects axially from the base, where the tip is in sliding contact with terminal ends of the first and second walls. In this example, the finger is a first finger and the tip is a first tip, where a second elongated finger that is shorter than the first finger depends from the planar portion having a second tip, where the second tip is in sliding contact with the terminal ends of the first and second walls. A semi-circular cutout is optionally formed through a portion of the base, where the first and second fingers project through the cutout, and where a radial width of the cutout changes along a length of the cutout from a distance less than a width of the tips to a distance greater than the widths of the tips. In an alternative, rotation of the pivot arm into the deployed configuration aligns a portion of the cutout having a radial width greater than the width of the tips with one of the tips and out of interfering contact with the tip. In a further alternative, when in the deployed configuration, the second tip registers with the portion of the cutout having a radial width greater than the width of the tips, so that the pivot arm drops past the second tip and is coupled to the cover by interfering contact between the first tip and terminal ends of the first and second walls. Embodiments exist that further include a pedestal depending axially away from the cover and through an opening formed axially through the pivot arm and a pin projecting radially from the pedestal. In this example, included is a third helical wall projecting axially from the base and circumscribed by the first and second walls, a terminal end of the third wall in sliding contact with the pin. Another embodiment further includes a mounting assembly having a fastener mounted to an overhanging structure, a post connected to the fastener, and a post head on an end of the post distal from the fastener. Optionally, the mounting assembly is a first mounting assembly, the post is a first post, and the head is a first head, the system further including a second mounting assembly having a second post and a second post head. In another alternative, first and second support surfaces are configured in stepwise fashion at different distances from an upper surface of cover, where the first and second post heads are selectively positioned on first and second support surfaces to maintain cover in a horizontal orientation.

Another example of a fire suppression system is disclosed that includes a cover secured to a lower facing surface of an overhanging structure and having an elongated finger depending downward, a pivot arm having a helical structure partially circumscribing an axis and projecting axially downward, the helical structure having a lower surface that varies in elevation about the axis and that is in abutting contract with a tip formed on the finger, so that when the pivot arm is biased away from the cover, the lower surface of the helical structure is in sliding contact with the tip and the pivot arm rotates about the axis, and a canister having fire suppressing material attached to a portion of the pivot spaced laterally away from the helical structure. In an example, the finger is a first finger and the tip is a first tip, the system further including a second finger depending downward from the cover and having a second tip that is in abutting contact with the lower surface of the helical structure at a location spaced angularly away from where the first tip is in abutting contact with the lower surface of the helical structure and balances supporting forces exerted onto the pivot arm by the first and second tips. In an alternative, the helical structure is a first helical wall and a second helical wall circumscribing the first helical wall, and where the first and second fingers extend into a radial space between the first and second walls. In embodiments, the pivot arm rotates from a retracted configuration to a deployed configuration, and where when in the deployed configuration the pivot arm drops below the second tip and is partially supported by the first tip. The system optionally further includes a first aperture on sidewalls of the cover and a second aperture on sidewalls of the pivot arm, and a fuse, where when the apertures are registered with one another, the fuse extends through the apertures and arrests rotation of the pivot arm with respect to the cover and wherein the fuse allows rotation of the pivot arm when degraded from being combusted.

### BRIEF DESCRIPTION OF DRAWINGS

Some of the features and benefits of the present invention having been stated, others will become apparent as the description proceeds when taken in conjunction with the accompanying drawings, in which:

FIGS. 1A-1J are overhead, plan, and perspective views of examples of a fire suppressing system in stowed and deployed configurations.

FIG. 2 is a perspective view of an example of a cover for use with the fire suppressing system of FIG. 1A.

FIGS. 3A-3D are overhead, plan, and perspective views of examples of a pivot arm for use with the fire suppressing system of FIG. 1A

While subject matter is described in connection with embodiments disclosed herein, it will be understood that the scope of the present disclosure is not limited to any particular embodiment. On the contrary, it is intended to cover all alternatives, modifications, and equivalents thereof.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term “about” includes +/−5% of a cited magnitude. In an embodiment, the term “substantially” includes +/−5% of a cited magnitude, comparison, or description. In an embodiment, usage of the term “generally” includes +/−10% of a cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

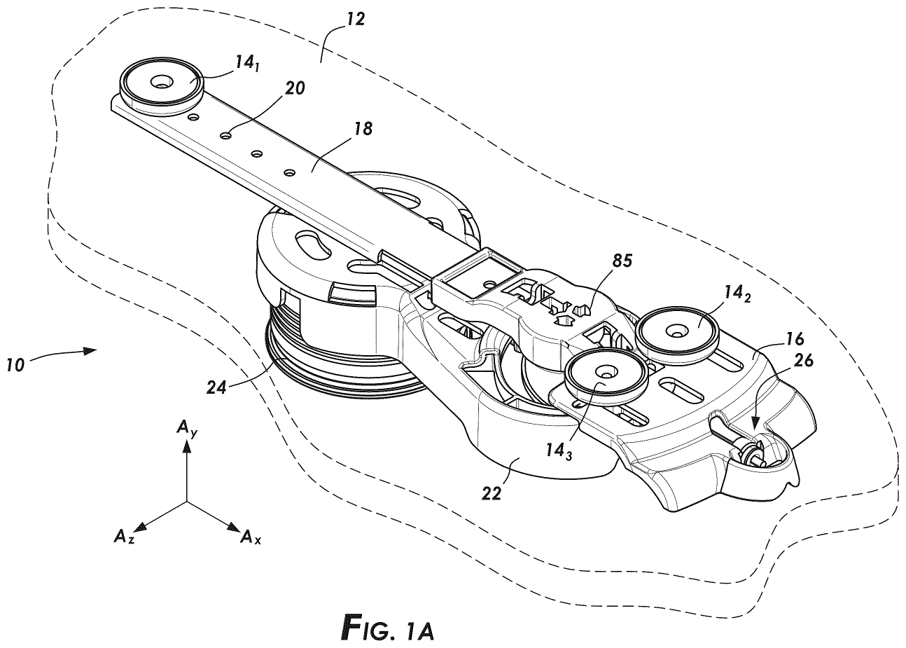

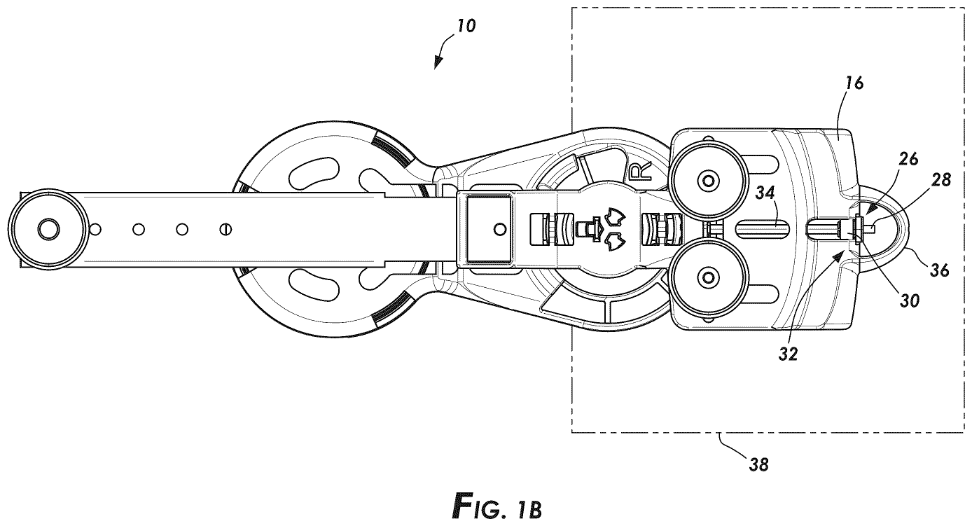

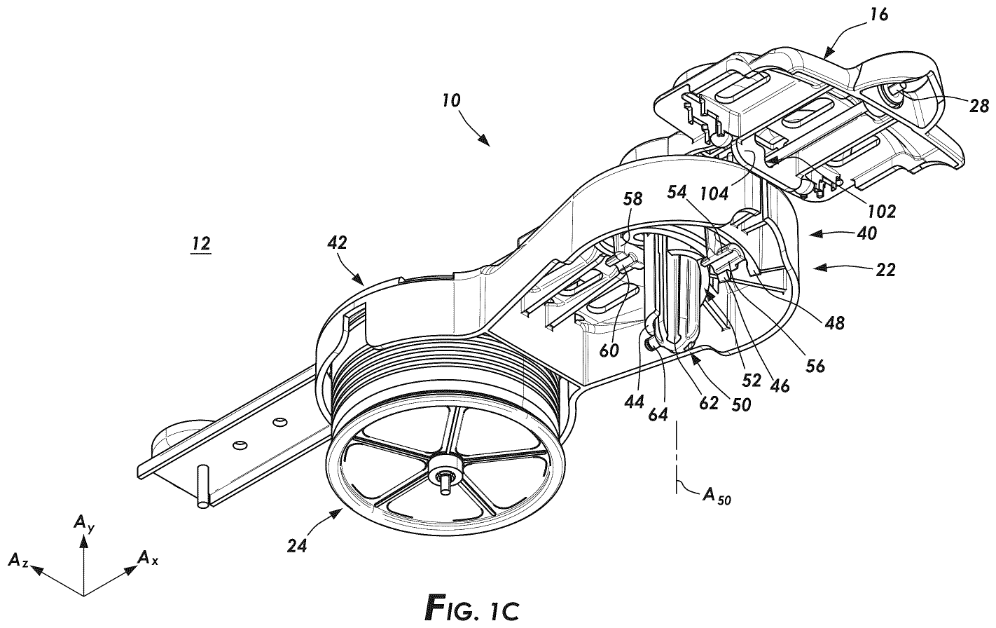

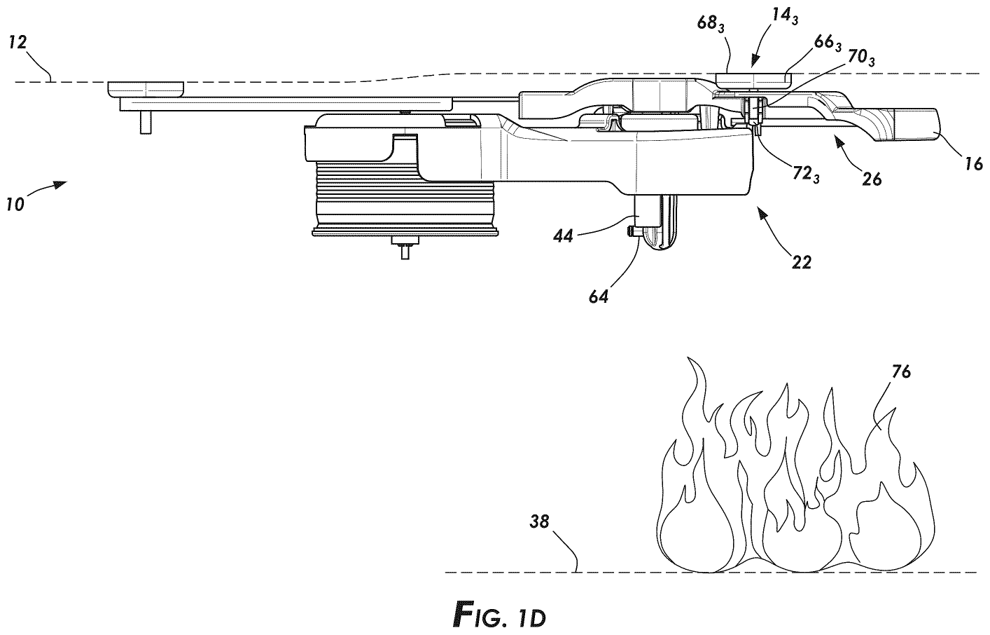

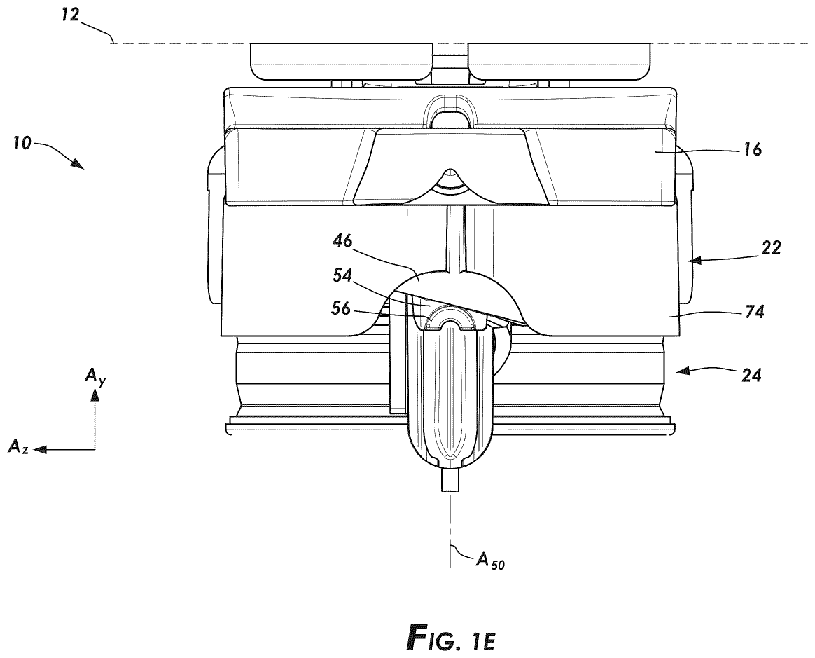

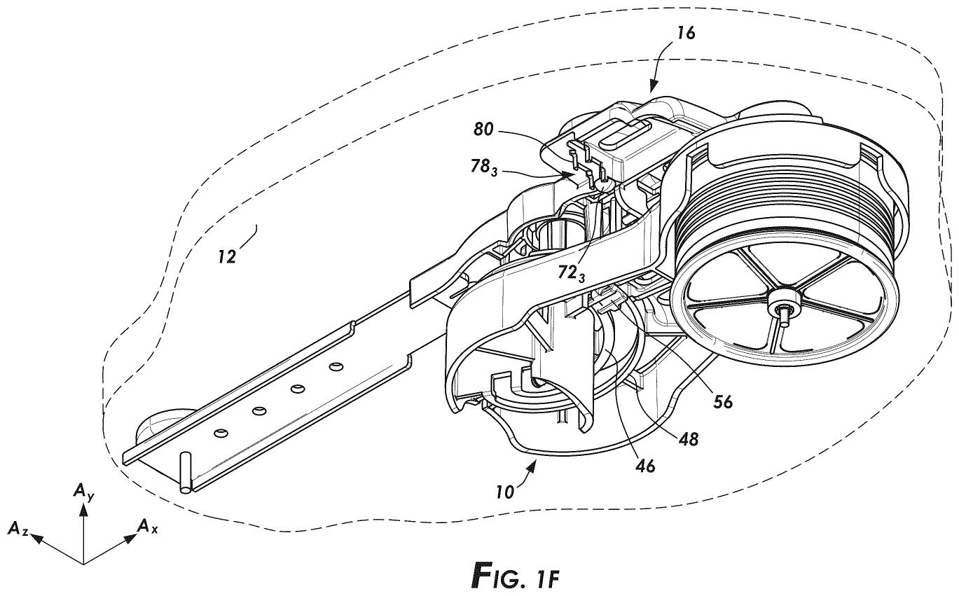

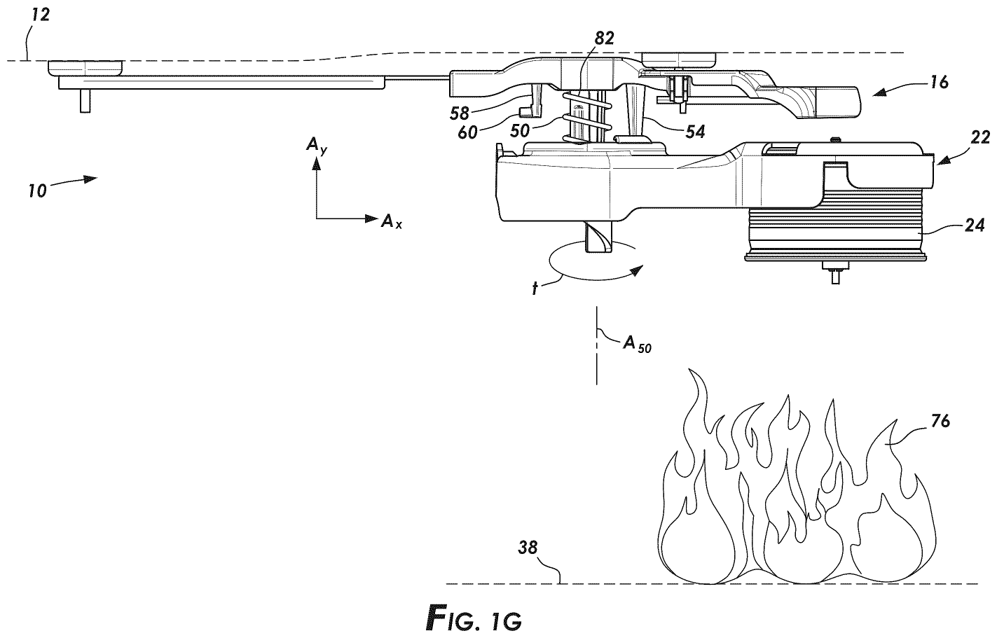

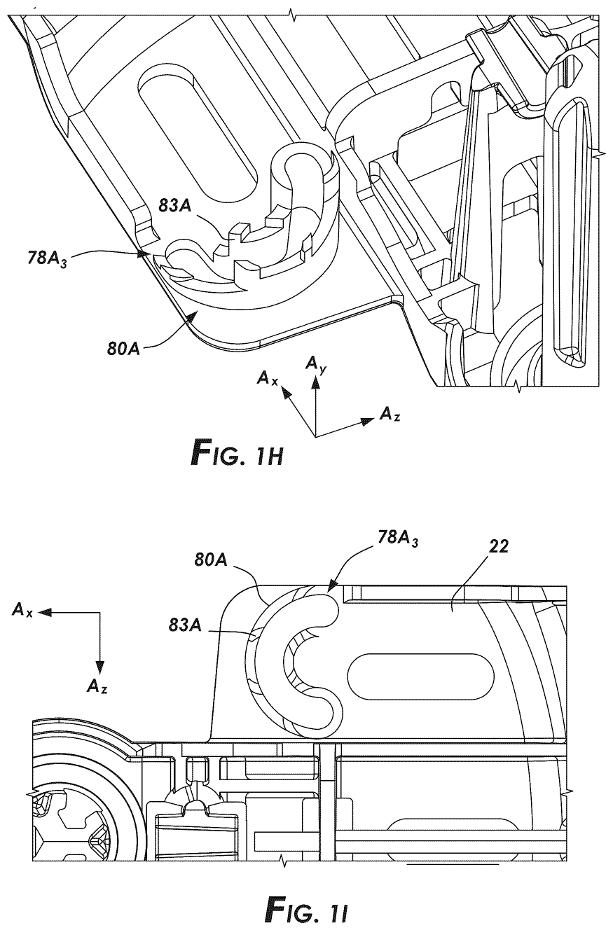

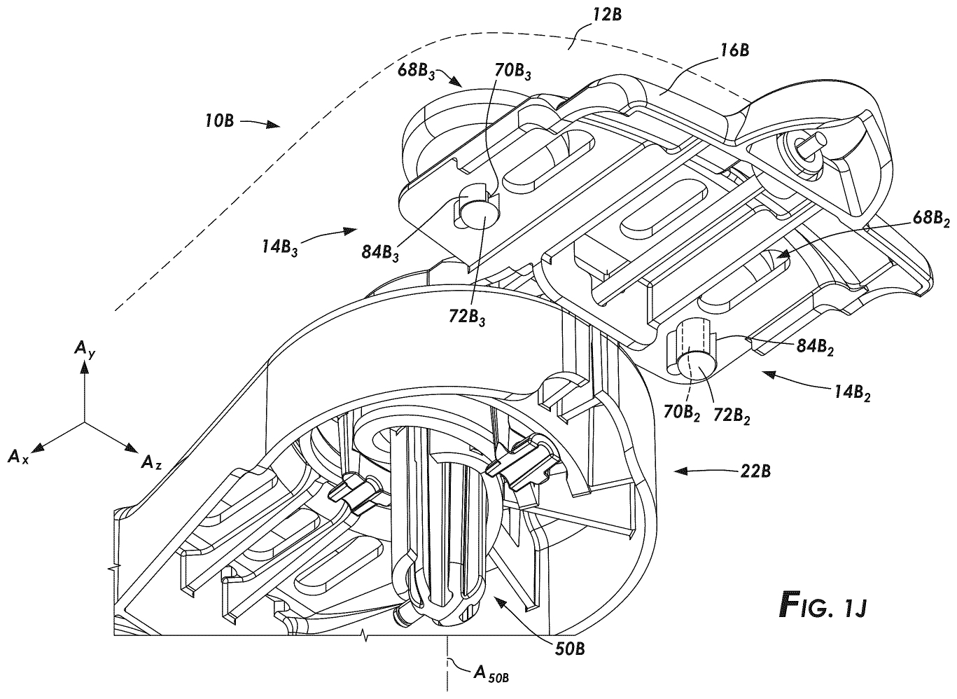

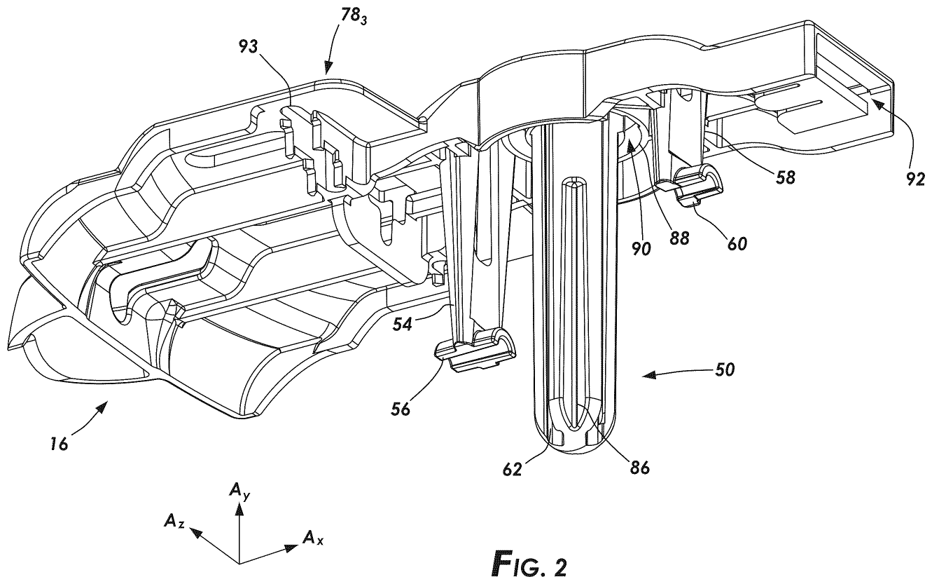

Shown in FIG. 1A is an overhead perspective view of an example of a fire suppression system 10. As shown, system 10 is mounted on a lower surface of a structure 12 (shown in phantom view) overhanging the system 10. Examples of structure 12 include microwaves, countertops, air vents, and other structures situated above an area having the potential for a potentially hazardous flame. Mounting assemblies 14₁₋₃ are shown as one example for mounting system 10 to structure 12. System 10 includes a cover 16 on which mounting assemblies 14_{2,3} are mounted, and an elongated beam 18 is shown coupled to a rearward end of cover 16, apertures 20 are formed through the beam 18 for securing mounting assembly 14₁. Fire suppression system 10 includes a pivot arm 22, which is rotatingly coupled to the cover 16. A canister 24 is attached to a lower facing surface of pivot arm 22. Examples of canister 24 are found in Procious et al. '101. A fuse assembly 26 is inserted axially into an upper end of cover 16, which as described in more detail below, selectively interferes with relative rotation of pivot arm 22 with the cover 16.

An overhead view of the fire suppression system 10 is shown in FIG. 1B and illustrating that fuse assembly 26 includes an elongated fuse 28 and a bushing 30, fuse 28 inserts into an axial passage formed in bushing 30. In examples, fuse 28 includes or is fully made up of an accelerant or other material for promoting combustion or detonation of fuse 28 when exposed to a flame, spark, high temperature (around 400° F. and greater), a high energy plasma, or combinations. Bushing 30 is an annular member shown secured to cover 16 by sliding bushing 30 into a slot 32 formed on an end of cover 32. Fuse assembly 26 includes an elongated barrel 34, a rearward portion of fuse 28 past bushing 30 is housed in the barrel 34. A semi-circular a fuse shroud 36 is shown having ends attached to a rearward end of cover 16 and arching over the free end of the fuse 28 shown projecting axially away from the cover 16. Fuse shroud 36 provides a protective covering for the free end of fuse 28 that is exposed outside of bushing 30. Fuse shroud 36 is further configured to direct any open flame present beneath system 12 onto fuse 28 to promote combustion of fuse 28 from an open flame. Shown in phantom view below the system 10 is a cooking surface 38.

FIG. 1C is an upward looking perspective view of an example of system 10, which illustrates that a forward portion of the pivot arm 22 defines a pivot section 40, and a rearward portion of pivot arm 22 where canister 24 is secured, defines a canister section 42. Helical walls 44, 46, 48 are formed within the pivot section 40. Upper axial edges of the walls 44, 46, 48 are attached to a downward facing surface of pivot arm 22 and walls 44, 46, 48 are generally parallel with axis A_{Y}. In examples, the portion of pivot arm 22 where walls 44, 46, 48 is referred to as a base. A cylindrically shaped pedestal 50 is shown projecting from a lower facing surface of cover 16 and through an opening 52 formed axially through the pivot arm 22 and in the pivot section 40. Helical walls 44, 46, 48 circumscribe pedestal 50 and have axial lengths that increase with a clockwise change in angular location about axis A₅₀. The radius of wall 48 exceeds radius of wall 46, and radius of wall 46 exceeds radius of wall 44, whereas the maximum axial length of wall 44 exceeds the maximum axial lengths of walls 46, 48, axial lengths of walls 46, 48 remain generally equal about axis A₅₀.

Still referring to FIG. 1C, an elongated finger 54 is shown depending axially downward from a lower surface of the cover 16 and projecting through a radial gap between wall 46 and wall 48. In examples, wherein finger 54 attaches to cover 16 is a generally planar portion. A tip 56 is attached to a lower terminal end of finger 54 which has a width exceeding a radial space between walls 46, 48, the surface of tip 56 facing upward is in simultaneous contact with the terminal ends of both wall 46 and wall 48. A second finger 58, shorter than finger 54, has a fixed end mounted to the downward facing surface of cover 16 and projects through the radial gap between walls 46, 48, which in the example shown is spaced rearward of finger 54 and approximately 180° about axis A₅₀ from finger 54 and is substantially parallel with finger 54. Second finger 58 has a tip 60 with an upward facing surface also in selective sliding contact with the terminal ends of walls 46, 48. When pivot arm 22 is rotationally static, the tips 56, 60 are in interfering contact with the lower terminal surfaces of walls 46, 48 and provide a supporting surface for walls 46, 48 and arm 22. Grooves 62 are shown formed lengthwise along an outer surface of the pedestal 50 and spaced generally equidistant from one another about axis A₅₀. In alternatives, pedestal 50 has a greater or lesser number of grooves 62. In one of grooves 62 is a pin 64 shown projecting radially outward from axis A₅₀, a lateral side of pin 64 is in supporting contact with the lower terminal end of wall 44. Further shown in FIG. 1C is the surface 12 above the system 10 and providing support for system 10 by interaction with mounting assemblies 14₁₋₃. As shown, wall 44 rests on pin 64, which provides axial support of the pivot arm 22 on the cover 16.

In FIG. 1D the mounting assembly 14₃ is shown made up of a fastener 66₃ that couples with surface 12. In the example shown, fastener 66₃ includes a partial housing and a magnet 683, within housing for attachment to the surface 12, on a lower facing surface of fastener 66₃ is a post 70₃ projecting axially through cover 16. A post head 72₃ is on an end of post 70₃ opposite fastener 66₃. In FIG. 1E is a front plan view of the system 10 illustrating the helical configuration of wall 46 and that its length changes at different angular positions about axis A₅₀, and as it is in sliding contact with the tip 56 of finger 54. A side wall 74 of pivot arm 22 is shown profiled so that its axial length varies along circumference of pivot arm 22.

The embodiments of system 10 illustrated in FIGS. 1A through 1E are shown in a stowed or retracted view and where the canister 24 is positioned a distance away from the forward end of the system 10 where cover 16 is located. Referring now to FIG. 1F, system 10 is shown in a deployed configuration in which the pivot arm 22 has rotated about pedestal 50 (FIG. 1E) so that the canister 24 is above an open flame 76 (FIG. 1D) schematically represented on the cooking surface 38. In a nonlimiting example of system 10, changing from a stowed configuration to a deployed configuration, the flame 76 initiates combustion of fuse 28 causing fuse 28 to degrade and no longer interfere with rotation of pivot arm 22 relative to cover 16. Referring back to FIG. 1F, a landing 78 is shown on a downward facing surface of cover 16. Formed on landing 78₃ are downward facing planar support surfaces 80 configured in stepwise fashion at different distances from an upper surface of cover 16. Adjacent support surfaces 80 vary in position along axis A_{Y}. Selectively positioning the post head 72₃ on the different support surfaces 80 changes the distance between cover 16 and surface 12 so that the distance of system 10 from the cooking surface 38 is selectively adjusted by positioning post head 72₃ on a particular support surface 80.

As shown in FIG. 1G, rotating pivot arm 22 about axis A₅₀ and approximately 180° from its stowed configuration to a deployed configuration positions canister 24 over flame 76. The heat from flame 76 initiates operation of canister 24 to release a fire suppressing agent contained within and extinguish flame 76. An example of operation of canister 24 in response to being exposed to a flame 76 is explained in Procious et al '101. Examples of fire suppressing agent include materials for controlling, reducing, and/or extinguishing a flame, such as a dry fire suppression powder. A biasing means 82, illustrated as a helical spring, is shown circumscribing pedestal 50, biasing means 82 exerts an axial biasing force between the pivot arm 22 and cover 16. Referring back to FIG. 1C, exertion of the biasing force urges the pivot arm 22 and walls 46, 48 downward so that the terminal ends of the helical walls 46, 48 are in compressive contact with the upper surfaces of tips 56, 60 of fingers 54, 58 as the pivot arm 22 is being rotated into its deployed configuration. Also in compressive contact during this time is the lower terminal end of wall 44 and pin 64. After being combusted, the fuse 28 (FIG. 1A) no longer has the structural integrity to interfere with rotation of the pivot arm 22 relative to cover 16. The biasing force from spring 82 urging pivot arm 22 away from cover 16 urges the pin 64 and tips 56, 60 against the obliquely configured terminal ends of walls 44, 46, 48, which creates resultant forces that generate a torque t about axis A₅₀ (in the plane that intersects axes A_{X} and A_{Z}), which is exerted against the pivot arm 22 to create the rotation about the pedestal 50 and position the canister 24 from its position in FIG. 1A to its deployed position of FIG. 1G shown over open flame 76. An advantage of the strategic placement of fingers 54, 58 and pin 64 about axis A₅₀ balances forces applied to the pivot arm 22 from the biasing force of the spring 82 and from gravity. Balancing these forces maintains the arm 22 in a substantially level orientation (i.e., in a plane substantially parallel with a plane of the cover 16) during rotation, which avoids binding between arm 22 and pedestal 50. As shown in the deployed configuration, pivot arm 22 has dropped downward from cover 16 so that the upper surface of cover 22 is below tip 60, and pivot arm 22 is supported by interfering contact between tip 56 and walls 46, 48 (FIG. 1F). Strategic dimensioning of the axial lengths (along axis A_{Y}) of fingers 54, 58 results in a distance of canister 24 from the flame 76 so that canister 24 is exposed to an adequate amount of heat from flame 76 to initiate its operation. In an example, the walls 44, 46, 48 are strategically formed so that pivot arm 22 rotates a rotational distance so that the cannister 24 is generally aligned with a forward end of cover 16 when in the deployed configuration.

An alternate example of a landing 78A₃ and support surfaces 80A are shown in perspective and upward looking views in FIGS. 1H and 1I. In this example, adjacent surfaces 80A extend along a helical path and reduce in height along a clockwise direction when looking upward, in this example, surfaces 80A of landing 78A₂ (not shown) on an opposite side of cover 22 along axis A_{Z} reduce in height along a counter-clockwise path, in alternatives, surfaces 80A on opposing sides follow the same clockwise or counter-clockwise path. Further shown are tabs 83A that extend vertically along axis A_{Y} and that are disposed between adjacent surfaces 80A. In alternatives, clips (not shown) are selectively attached to the posts 70 or post heads 72 (FIG. 1F) to secure the posts 70 at a designated location along the helical path of the support surfaces 80A.

Shown in FIG. 1J is an embodiment of an alternate embodiment of the system 10B that includes clips 84B_{2, 3} for securing the mounting assemblies 14B_{2, 3} to the cover 16B. Clips 84B_{2, 3} further provide the ability to selectively adjust the vertical position of the mounting assemblies 14B_{2, 3} to compensate for contours or vertical offsets of the surface 12B. Vertical compensation is achieved by the clips 84B_{2, 3} having variable lengths (e.g., dimensions along axis A_{Y}) to maintain post heads 72B_{2, 3} at different distances from the lower surface of cover 16B, that in turn places magnets 68B_{2, 3} at different vertical positions. Compensating for the vertical offsets of the surface 12B maintains the cover 16B and pivot arm 22B in a level orientation, i.e., axis A_{50B} of pedestal 50B is substantially parallel with axis A_{Y}, which balances pivot arm 22B about pedestal 50B to minimize resultant forces along axis A_{Y} from interaction between arm 22B and pedestal 50B and not impede rotation of pivot arm 22B about pedestal 50B.

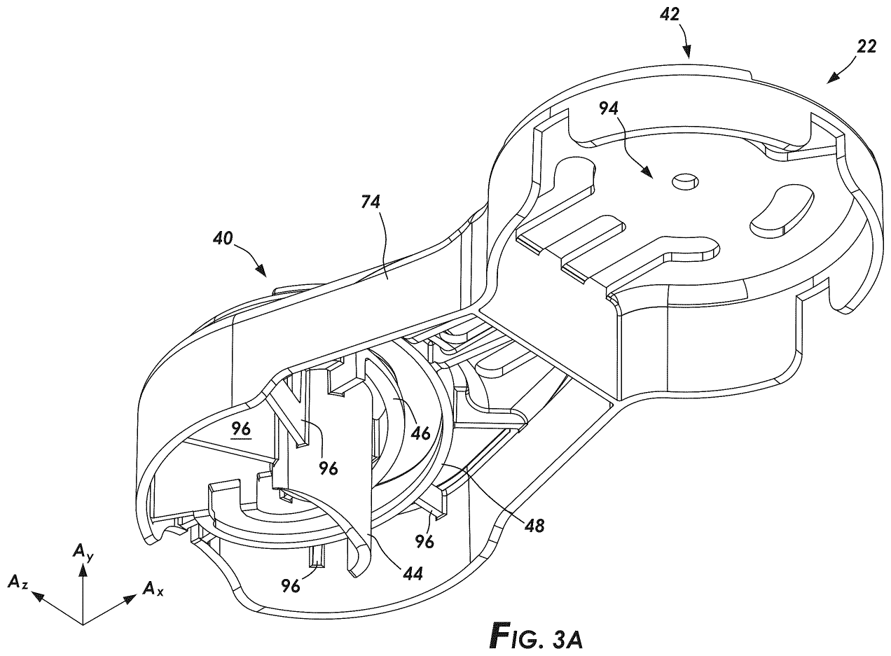

FIG. 2 is an upward looking perspective view of an example of the cover 16. As shown, the fingers 54, 58 are generally elongate axial members that extend along axis A_{Y} and have a fixed end secured to the downward facing surface of cover 16. Terminal ends of fingers 54, 58 include the tips 56, 60 shown generally parallel with axis A_{X}. Upper surfaces of the tips 56, 60 are curved having apexes that coincide with midpoints of tips 56, 60, and are semicircular. As shown in FIG. 2, grooves 62 extend along an axial length of the pedestal 50 and register with holes 85 (FIG. 1A) formed axially through the cover 16. Between adjacent grooves 62 are grooves 86 that extend axially along a portion of pedestal 50 and have lengths less than those of grooves 62. Projecting axially away from a downward facing surface of cover 16 is a wall 88 that circumscribes pedestal 50 and forms an annular receptacle 96 that receives spring 82 (FIG. 1G). A generally rectangular pocket 92 is shown on a rearward end of cover 16, pocket 92 has a cross section configured to receive an end of beam 18 (FIG. 1A) distal from the apertures 20. Also shown are slots 93 that are part of the landing 78₃ for receiving the post 70₃ of the mounting assemblies 14₁₋₃, slots 93 extend on axis A_{Z} a distance to allow for selective placement of the magnets 14₁₋₃ at different heights, which as described above provides an advantage of adjusting the elevation of cover 16 and the system 10. In examples when the surface 12 is vertically contoured, an additional advantage of the mounting assemblies 14₁₋₃ being independently vertically adjusted is realized by positioning individual mounting assemblies 14₁₋₃ to compensate for vertical offsets of the surface 12.

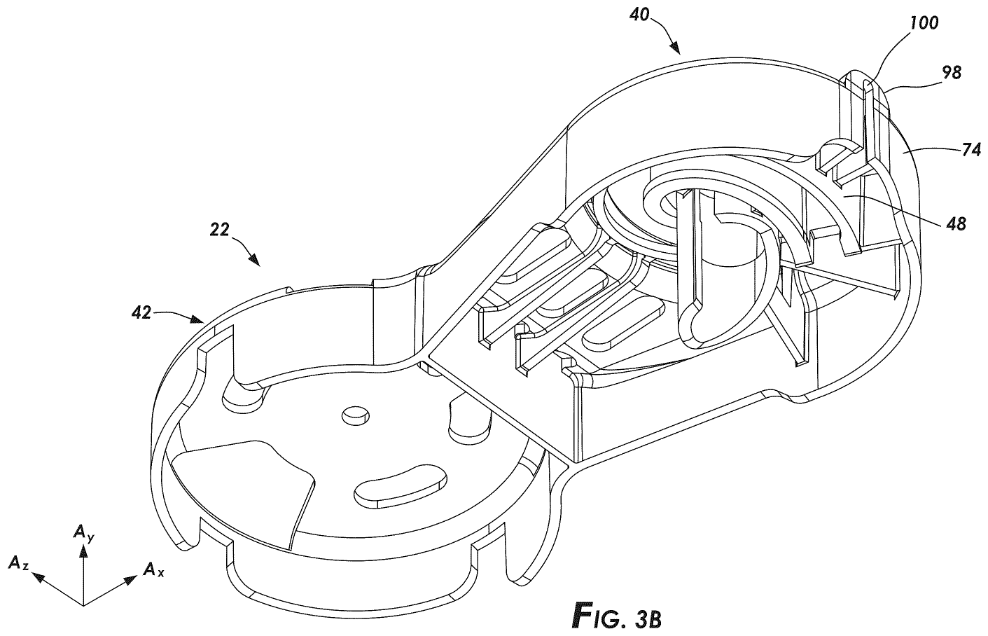

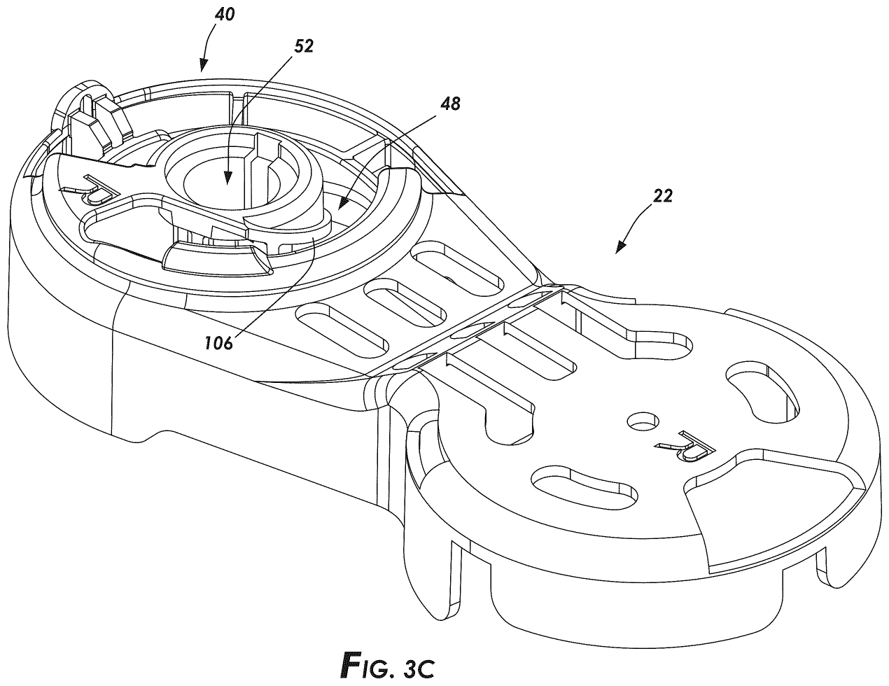

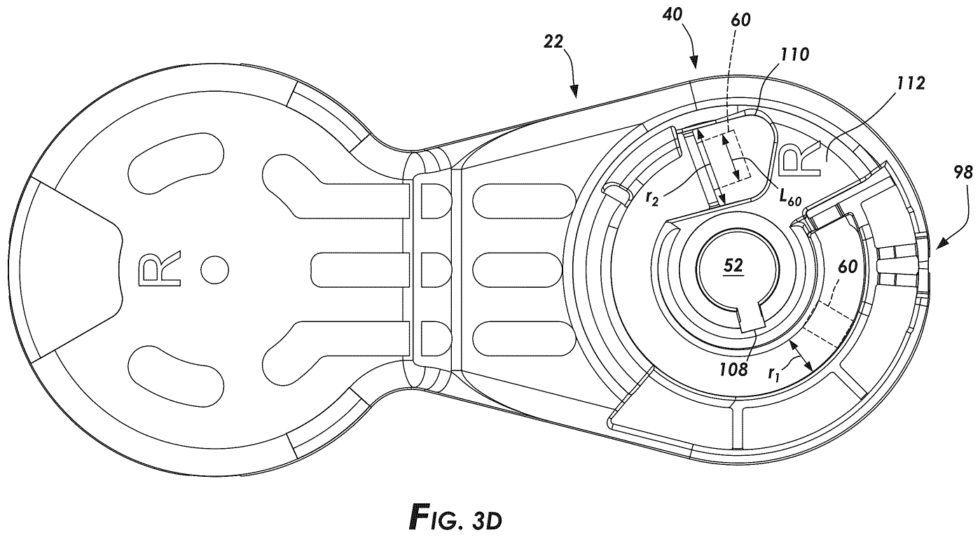

Referring now to FIG. 3A, shown is an upward looking perspective view of an example of the pivot arm 22 in which sidewalls 74 of the pivot arm 22 form a receptacle 94 in the canister portion 42 of the pivot arm 22. Receptacle 94 selectively receives the canister 24 (FIG. 1A). Shown in the pivot section 40 are girders 96 that project radially outward from walls 44, 46, 48 and to sidewalls 74, girders 96 provide structural support for walls 44, 46, 48. FIG. 3B, is an alternate angle of an upward looking perspective view of the pivot arm 22 and illustrating a tab 98 extending upward from side wall 74 and generally parallel with axis A_{Y} and on and end of the pivot section 40 distal from the canister section 42. Formed radially through tab 98 is an opening 100, which when registered with opening 102 on a skirt 104 (FIG. 1C) provides a space for insertion of fuse 28 to interfere with and arrest relative rotation of pivot arm 22 with respect to the cover 16. In FIG. 3B, the outer wall 48 is shown projecting axially along axis A_{Y} and past a lower terminal end of side walls 74. Referring to FIG. 3C, an overhead view of the pivot arm 22 is shown which illustrates that a lip 106 is formed on an upper portion of wall 48 that projects radially outward from opening 52 formed in the pivot section 40 of pivot arm 22. An overhead view of the pivot arm 22 is shown in FIG. 3D and depicts a slot 108 that projects radially outward from opening 52 and that extends axially along the opening 52. Slot 108 provides an opening for insertion of pin 64 during assembly of system 10. A C-shaped and semi-circular cutout 110 is shown formed axially through the base surface 112 of pivot section 40 and substantially circumscribing opening 52. A portion of cutout 110 proximate tab 98 and slot 108 has a radial width r₁ less than a length L₆₀ of tip 60, a portion of cutout 110 distal from slot 108 has a radial width r₂ exceeding the length L₆₀ of tip 60. When system 10 is in the stowed configuration (FIG. 1C), tip 60 is in interfering contact with the portion of cutout 110 having radial width r₁ so that base surface 112 is supported on tip 60, and when moved into the deployed configuration (FIG. 1G), the tip 60 is adjacent the portion of cutout 110 has a radial width r₂ greater than Leo, which allows tip 60 and finger 58 to fall below cover 16. An advantage provided by cutout 110 is that the system 10 occupies a smaller vertical space when in the stowed configuration while still dropping to an elevation in closer proximity to flame 76 (FIG. 1G) when in the deployed configuration.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

What is claimed is:

1. A fire suppression system comprising:
a cover having a planar portion and an elongated finger depending from the planar portion;
a pivot arm having a base with a helically shaped wall projecting axially therefrom and having a terminal end in interfering contact with an end of the finger, so that when biased away from the cover the pivot arm rotates with respect to the cover from a stowed configuration to a deployed configuration; and
a canister secured to the pivot arm containing a fire suppressant.

2. The system of claim 1, wherein the terminal end of the wall is in sliding contact with a tip formed on an end of the finger.

3. The system of claim 2, wherein the wall comprises a first wall, wherein a second helically shaped wall projects axially from the base, wherein the tip is in sliding contact with terminal ends of the first and second walls.

4. The system of claim 3, wherein the finger comprises a first finger and the tip comprises a first tip, wherein a second elongated finger that is shorter than the first finger depends from the planar portion having a second tip, wherein the second tip is in sliding contact with the terminal ends of the first and second walls.

5. The system of claim 4, wherein a semi-circular cutout is formed through a portion of the base, wherein the first and second fingers project through the cutout, and wherein a radial width of the cutout changes along a length of the cutout from a distance less than a width of the tips to a distance greater than the widths of the tips.

6. The system of claim 5, wherein rotation of the pivot arm into the deployed configuration aligns a portion of the cutout having a radial width greater than the width of the tips with one of the tips and out of interfering contact with the tip.

7. The system of claim 6, wherein when in the deployed configuration, the second tip registers with the portion of the cutout having a radial width greater than the width of the tips, so that the pivot arm drops past the second tip and is coupled to the cover by interfering contact between the first tip and terminal ends of the first and second walls.

8. The system of claim 3, further comprising a pedestal depending axially away from the cover and through an opening formed axially through the pivot arm and a pin projecting radially from the pedestal.

9. The system of claim 8, further comprising a third helical wall projecting axially from the base and circumscribed by the first and second walls, a terminal end of the third wall in sliding contact with the pin.

10. The system of claim 1, further comprising a mounting assembly having a fastener mounted to an overhanging structure, a post connected to the fastener, and a post head on an end of the post distal from the fastener.

11. The system of claim 10, wherein the mounting assembly comprises a first mounting assembly, the post comprises a first post, and the head comprises a first head, the system further comprising a second mounting assembly having a second post and a second post head.

12. The system of claim 11, wherein first and second support surfaces are configured in stepwise fashion at different distances from an upper surface of cover, wherein the first and second post heads are selectively positioned on first and second support surfaces to maintain cover in a horizontal orientation.

13. A fire suppression system comprising:
a cover secured to a lower facing surface of an overhanging structure and having an elongated finger depending downward;
a pivot arm having a helical structure partially circumscribing an axis and projecting axially downward, the helical structure having a lower surface that varies in elevation about the axis and that is in abutting contract with a tip formed on the finger, so that when the pivot arm is biased away from the cover, the lower surface of the helical structure is in sliding contact with the tip and the pivot arm rotates about the axis; and
a canister having fire suppressing material attached to a portion of the pivot spaced laterally away from the helical structure.

14. The system of claim 13, wherein the finger comprises a first finger and the tip comprises a first tip, the system further comprising a second finger depending downward from the cover and having a second tip that is in abutting contact with the lower surface of the helical structure at a location spaced angularly away from where the first tip is in abutting contact with the lower surface of the helical structure and balances supporting forces exerted onto the pivot arm by the first and second tips.

15. The system of claim 14, wherein the helical structure comprises a first helical wall and a second helical wall circumscribing the first helical wall, and wherein the first and second fingers extend into a radial space between the first and second walls.

16. The system of claim 14, wherein the pivot arm rotates from a retracted configuration to a deployed configuration, and wherein when in the deployed configuration the pivot arm drops below the second tip and is partially supported by the first tip.

17. The system of claim 13, further comprising a first aperture on sidewalls of the cover and a second aperture on sidewalls of the pivot arm, and a fuse, wherein when the apertures are registered with one another, the fuse extends through the apertures and arrests rotation of the pivot arm with respect to the cover and wherein the fuse allows rotation of the pivot arm when degraded from being combusted.
